(19) United States
(12) Patent Application Publication
(10) Pub. No.: US 2015/0168163 A1
(43) Pub. Date: Jun. 18, 2015

(54) METHOD FOR ENHANCED GPS NAVIGATION

(71) Applicant: Douglas Chase, Watertown, MA (US)

(72) Inventor: Douglas Chase, Watertown, MA (US)

(21) Appl. No.: 14/104,190

(22) Filed: Dec. 12, 2013

(51) Int. Cl. G01C 21/34

(52) U.S. Cl. CPC G01C 21/34

(57) ABSTRACT

A GPS navigation system and method that includes the steps of identifying a destination; managing a route for the destination; pinpointing a geographical location for the destination; and optimizing a route to ensure that the geographical location coincides with the passenger side of a user vehicle upon arrival. The method in accordance with the present invention pinpoints the geographical location of a destination in correlation to the side of the road that the destination is positioned.

### BACKGROUND OF THE INVENTION

1. Field of Invention

The present invention relates to an application that enhances GPS navigation for use with a motor vehicle.

2. Description of Related Art

Global Positioning System (GPS) navigation is a well-known system that's used to locate and navigate the position of a vehicle or vessel through the use of space-based satellites. Initially this system was used for military purposes but has now been developed and implemented in several civilian applications. GPS is used in marine vessels, motor vehicles and further in simple handheld applications. Typically GPS has a receiver that transmits signals to and from satellites in order to exactly position the location of the user. The system is normally used for directional purposes in a motor vehicle. Due to the proliferation of GPS systems grids of several locations have been graphically mapped and presently used in conjunction with GPS navigation. Typically a user inputs a destination, the GPS system locates the present location of the user and provides a directional route for the user to use. Many times these routes are fairly easy to follow and are accurate in a large percentage of the cases. The proliferation of the GPS has also allowed the implementation of GPS systems in handheld devices such as a cell phone in some instances a specific GPS receiver.

One drawback to the GPS system is that the GPS system pinpoints the destination and simply routes the user through a directional path along the available roadway. This route normally fails to take into consideration the geographical position of the destination and simply leads the user to the destination without concern of the location with respect to the position the user vehicle. If a user is approaching a destination the user may not realize which side of the road the destination lies. Consequently, it would be advantageous to have an application that may be implemented with a GPS system to pinpoint the geographical position of the destination with respect to the side of the road or street that the destination lies upon.

### SUMMARY OF THE INVENTION

The present invention relates to GPS navigation system and method that includes the steps of identifying a destination; managing a route for the destination; pinpointing a geographical location for the destination; and optimizing a route to ensure that the geographical location coincides with the passenger side of a user vehicle upon arrival. The method in accordance with the present invention pinpoints the geographical location of a destination in correlation to the side of the road that the destination is positioned. Therefore the application according to present invention identifies if the geographical location is on the east, west, north, or south side of a particular street based upon street direction. The application then optimizes the route provided for the user to ensure that the passenger's side coincides with the geographical location of the destination.

### DETAILED DESCRIPTION

The present invention relates to a method of route optimization while using a GPS navigation system. The GPS navigation application according to present invention optimizes the route developed for a particular destination. The application according to present invention receives input from the user for a desired destination. After a desired destination is selected, the GPS pinpoints the destination's geographical location and optimizes the route for the user. Part of the step for optimizing includes ensuring that the user's vehicle is positioned in a manner that the passenger side of the vehicle coincides with the geographical location of the destination.

The present invention is a method that goes through a sequence of steps normally associated with a GPS navigation. The GPS navigation pinpoints a destination through the use of known GPS technology. Once this destination is pinpointed, the system optimizes the route to arrive at the destination. The optimized route is optimized in a manner that the geographical location of the destination is pinpointed on the roadway. Normally roadway includes at least two lanes of traffic traveling in opposite directions. As a consequence, the destination may be positioned on a east side or west side if the directional path is north and south. If the directional path is east and west, then the destination would be on either a north and south side of the road. The present invention pinpoints this destination based upon the traffic direction of the roadway. After pinpointing this destination the route is optimized to ensure that upon arrival the user's vehicle is positioned so that the passenger's side coincides with the destination side or address. The instant invention has been shown and described in what it considers to be the most practical and preferred embodiments. It is recognized, however, that departures may be made there from within the scope of the invention and that obvious modifications will occur to a person skilled in the art.

1. A method of using a GPS navigation system for a vehicle comprising the steps of:
identifying a destination location on the GPS navigation system;
developing a route to arrive at the destination location with the GPS navigation system;
pinpointing a geographical position of the destination location with respect to the traffic direction of the roadway with the GPS navigation system;
optimizing the route with the GPS navigation system to ensure that the geographical location coincides with a passenger side of the vehicle while using the optimized route.

2. The method of using the GPS navigation system in accordance with claim 1, where the geographical location includes at least one of an east, west, north, or south side of a street or roadway associated with the destination.

3. The method of using the GPS navigation system in accordance with claim 2 where the geographical location depends upon roadway directional traffic.

4. The method of using the GPS navigation system according to claim 1 where the passenger's side of a user vehicle is on at least one of a left side or right side.
